(19) United States
(12) Patent Application Publication
(10) Pub. No.: US 2016/0067632 A1
(43) Pub. Date: Mar. 10, 2016

(54) MACHINE FOR PROCESSING POLYMER MATERIALS

(71) Applicant: NEXXUS CHANNEL S.R.L., Oleggio (IT)

(72) Inventor: Giuseppe Ponzielli, Cittiglio (IT)

(73) Assignee: Nexxus Channel S.r.l., Oleggio (IT)

(21) Appl. No.: 14/783,835

(22) PCT Filed: Apr. 11, 2014
(86) PCT No.: PCT/IB2014/060667

§ 371 Date: Oct. 9, 2015

(30) Foreign Application Priority Data
Apr. 12, 2013 (IT) MI2013A000601

(51) Int. Cl. B01D 19/00; B29B 7/52

(52) U.S. Cl. CPC B01D 19/0036; B29B 7/52

(57) ABSTRACT

A machine (1) for processing polymer materials has a rotor (2) rotatable around an axis of rotation (A); a stator (3) slidingly and sealingly coupled with the rotor (2); at least one circumferential recess (7) which extends by an angle of less than 360° into the stator (3) and forms with the rotor (2) a processing channel (8) of the polymer material; at least one inlet channel (11) for feeding the polymer material to the processing channel (8); and an outlet channel (12) for evacuating the polymer material from the processing channel (8).

### TECHNICAL FIELD

The present invention concerns a machine for processing polymer materials.

In particular, the present invention concerns a machine comprising a stator and rotor rotatable around an axis of rotation and coupled with the rotor, and a processing channel between the stator and the rotor for processing the polymer materials.

### BACKGROUND ART

The invention refers in general to machines of the type identified above and configured to process polymer materials by melting or mixing or degassing of at least two components, the first of which is a viscous liquid and the second another viscous liquid or a solid in particles or a gas or a combination of the above-mentioned elements.

The machines for processing polymer materials of the type identified above comprise screw machines or screw extruders in which a screw is rotatable inside a cylinder so as to define a helical processing channel.

The screw machines have some drawbacks.

Firstly, in the screw machines the flow rate of polymer material is limited by the fact that the width of the flow channel is a function of the screw pitch which, in turn, is a function of the angle of the screw and the thickness of the screw thread, and by the fact that there are two speed components of the flow of polymer material, only one of which contributes to the flow of the material towards the outlet, determining the ejection flow rate. The flow of polymer material has a speed component parallel to the threads, a function of the cosine of the screw angle, and a speed component perpendicular to the threads, a function of the sine of the screw angle, which does not contribute to the flow of the material inside the channel, towards the outlet. Due to this distribution of the speed components, it is not physically possible to know which fluid particles progress along one or the other of the two paths. In particular, it is not possible to know which particles progress along the circumferential path, perpendicular to the threads, whereas this would be of particular interest, in some cases, to control the speed profile of the liquid and its deformation, along that trajectory.

The screw machines also have further problems such as insufficient and inefficient elongational dispersion of the liquid, insufficient and inefficient degassing of the liquid-gas binary mixtures, and insufficient and inefficient melting of the solid thermoplastic substances.

In the first two cases, the process problems are connected with the passage of the liquid particles through the gap between the thread and the cylinder. In these cases, in fact, a considerable number of liquid particles are arranged along the trajectory parallel to the threads, instead of along the circumferential trajectory perpendicular to the threads, escaping from the desired process. To remedy this drawback, a known solution is to increase the local circumferential flow rate of the extruder by elongation of the sections concerned. This increases the probability of all the particles being “deformed” in the desired way. The required flow rate increase is normally very significant and ranges from a theoretical minimum of 4.6 times to over 20 times the ejection flow rate. However, the design of mixing or degassing areas much longer than necessary results in considerable drawbacks including higher investment, greater space occupied, lower energy efficiency and the risk of degradation of the polymer materials.

Lastly, screw machines are subject to fouling in the area of the degassing flue. In screw machines the degassing takes place through the thin film of liquid that forms above the surface of the cylinder, at the liquid/gas interface. Since at least one fraction, however small, of polymer material must necessarily come into contact with both the cylinder and the screw to permit the feed thereof, this fraction of material that comes into contact with both the cylinder and the screw is obliged to pass in front of the degassing flue, once every turn, and therefore “dirties” the flue area.

In order to mitigate the above drawbacks, machines have been conceived to process polymer materials with annular processing channels, in other words not helical.

For example, from the U.S. Pat. No. 5,200,204 (Douglas J. Horton), U.S. Pat. No. 4,012,477 (Beck), U.S. Pat. No. 4,813,863 (Granville J. Hahn), U.S. Pat. No. 4,501,543 (Rutledge), U.S. Pat. No. 3,880,564 (Beck) a type of machine is known comprising a cylindrical rotor, a stator having a seat for the rotor and a processing channel formed between the rotor and the stator. The annular processing channel is formed due to the fact that the seat of the stator is of larger diameter than the diameter of the rotor, which is mounted in a rotatable manner around an axis of rotation eccentric with respect to the seat, or the seat has an elliptical form.

Another type of machine for processing polymer materials is shown by U.S. Pat. No. 4,194,841 (Z. Tadmor), U.S. Pat. No. 4,606,646 (S. Metha) and WO2008071782 (G. Ponzielli). All the patents identified above show extruders having annular processing channels formed in the rotor.

The main drawback of the types of machines identified above lies in the fact that it is neither possible in some cases nor simple in others to vary the height of the processing channel locally and, therefore, define the processing channel according to specific needs, point by point, along the path.

### DISCLOSURE OF INVENTION

The object of the present invention is to provide a machine of the type identified above which is free from the drawbacks of the known art.

In accordance with the present invention, a machine is provided for processing polymer materials, the machine comprising a rotor rotatable around an axis of rotation; a stator sealingly coupled with the rotor; at least one circumferential recess which extends along an angle of less than 360° in the stator and forms with the rotor a processing channel for the polymer material; at least one inlet channel for feeding the polymer material to the processing channel; and one outlet channel for evacuating the polymer material from the processing channel.

Thanks to the present invention it is possible to provide a processing channel having geometrical characteristics suited to the type of processing for which the machine must be designed and without particular structural constraints.

According to a preferred embodiment of the present invention, the recess extends in an annular direction orthogonal to the axis of rotation.

In this way, the speed of the polymer material has one single component and, in the vicinity of the rotor wall, corresponds substantially to the speed of the rotor, when the material is liquid.

Preferably, the recess has a constant width measured parallel to the axis of rotation.

The constant width allows a regular flow rate of polymer material. However, non-constant widths, around the circumference of rotation, can be provided without any problem, for example to promote two-dimensional elongation of the liquid.

Preferably, the bottom face of the recess is arranged at a distance from the rotor so as to determine a variable height of the processing channel.

The variable height of the processing channel allows the design of processing channels having different purposes such as the melting or degassing of the polymer material or the infiltration or dispersion of agglomerates of elementary solid particles in the polymer matrix or, lastly, the dispersion of one or more liquids in one or more further liquids.

According to a preferred embodiment of the present invention, the processing channel comprises a first portion arranged at the inlet channel having a constant height; a second portion arranged at the outlet channel having a constant height lower than the height of the first section, with pumping effects, and a third portion included between the first and the second portion, having gradually decreasing height with an initial height equal to that of the first portion and a final height equal to that of the second portion.

The configuration of the first portion serves to stabilise the material; the configuration of the third portion serves to compress the solid material on the surface of the rotor or to “lengthen” the liquid material, imparting elongational type stress, while the configuration of the second portion serves to generate positive pressure gradients to overcome the pressure losses at the outlet.

In a variation of this preferred embodiment, the third portion arranged between the first and the second portion contains a series of converging areas, each followed by diverging areas. The reason for this variation is to provide a plurality of sequential converging areas, by increasing the number of “elongations” which the material is forced to undergo before coming out of the processor.

The converging/diverging sections promote dispersion of the agglomerates and the mixing of incompatible liquids, according to geometric variables such as, above all, the angle of convergence of the channel, the length of the portion and speed of the rotor.

According to a further preferred embodiment of the present invention, the processing channel comprises a first portion having a constant height and a third portion having a constant height lower than the height of the first portion, with pumping effects. This configuration is particularly preferred for degassing liquid mixtures. In this configuration the liquid is spread like a thin film on the surface of the rotor, so that a significant constant distance forms, for example of a few millimetres, between the surface of the exposed film and the wall above the cylinder. Thanks to this configuration, the creation of a constant vacuum on the exposed face of the film, for example by applying a vacuum pump to the processing chamber, is particularly easy and effective. As will be seen in some detail further on, the thickness of the film is determined by the density of the liquid, the width of the channel, the volumetric flow rate of the liquid and the speed of the rotor and by other material parameters such as the diffusion coefficient of the gas through the liquid.

Preferably, the rotor has a smooth cylindrical outer face.

The processing channel is provided completely in the stator.

According to a preferred embodiment of the present invention, the machine comprises a feed channel for feeding to the processing channel agglomerates of elementary particles configured to be infiltrated and dispersed respectively in a polymer matrix.

This configuration allows composite polymer materials to be obtained.

Preferably the inlet channel comprises two inlet mouths arranged in sequence along the processing channel upstream and downstream respectively of the aperture for feeding the agglomerates of elementary particles so as to feed the agglomerates between two layers of liquid polymer material.

Thanks to this configuration it is possible to sandwich the agglomerates of elementary particles between two layers of polymer materials and, therefore, promote infiltration and dispersion of the agglomerates.

According to a further preferred embodiment of the present invention, the machine comprises a degassing channel configured to eject the gases generated during processing of the polymer material.

It is particularly advantageous to spread a thin film of polymer material on the rotor so as not to dirty the degassing channel inlet and leave a part of the processing channel free so as to define a degassing chamber.

According to a preferred embodiment of the present invention, the machine comprises a recirculation system for recirculating, outside the processing channel, a fraction of polymer material in the liquid/pasty state which escapes from the opposite sides of the processing channel, due to the positive pressure gradient that forms along the path in the direction of the outlet, again in the processing channel, preferably returning to the central area of the processing channel. This system has proved to be excellent for eliminating the liquid leaks through the lateral seals in the vicinity of the bearings, since the recirculation flow rate of the escaped liquid is much greater than the flow rate of the lateral leak.

According to a preferred embodiment of the present invention, the stator comprises a body; and a tubular element arranged around the rotor and in sliding contact with the rotor, and sealingly coupled with the body; said at least one recess being formed along the inner face of the tubular element.

This construction embodiment is particularly simple and advantageous.

Indeed, the tubular element facilitates the provision of conduits having complex forms inside the stator.

Preferably, the tubular element has at least one further recess formed along the outer face of the tubular element and configured to define, in part, the processing chamber liquid inlet conduit.

### BRIEF DESCRIPTION OF THE DRAWINGS

Further characteristics and advantages of the present invention will appear clear from the following description of non-limiting embodiment examples, with reference to the figures of the accompanying drawings, in which:

FIG. 1 is a cross-section view, with parts removed for clarity, of a machine for processing polymer materials produced according to a first embodiment of the present invention;

FIG. 2 is a cross-section view, with parts removed for clarity, of a detail of the machine of FIG. 1;

FIG. 3 is a schematic view, with parts in section and parts removed for clarity, of a flat development of a part of the machine of FIG. 1;

FIGS. 4 to 7 are longitudinal section views, with parts removed for clarity, of different variations of a second embodiment;

FIG. 8 is a cross-section view, with parts removed for clarity, of a machine for processing polymer materials according to a further variation of the second embodiment of the present invention;

FIG. 9 is a perspective view, with parts removed for clarity, of components of the machine of FIG. 8;

FIG. 10 is a cross-section view, with parts removed for clarity, of a variation of the machine of FIG. 8;

FIG. 11 is a cross-section view, with parts removed for clarity, of a machine for processing polymer materials and incorporating a further variation;

FIG. 12 is a longitudinal section view, with parts removed for clarity, of the machine of FIG. 11; and

FIG. 13 is a schematic view in side elevation, with parts removed for clarity, of a plant for processing polymer materials.

### BEST MODE FOR CARRYING OUT THE INVENTION

With reference to the figure, 1 indicates as a whole a machine for continuous processing of a polymer material. For the purposes of this description, the term processing means both jointly and separately melting the polymer material, degassing the polymer material, infiltrating the polymer material between particles and/or fibres, dispersing the particles and/or fibres in the polymer material and dispersing one or more liquids in one or more other liquids. The term polymer material indicates both thermoplastic polymer materials, such as the polyolefins LDPE, LLDPE, HDPE, PP etc., polystyrene, ABS, polyamide 6, 66, 11, 12 etc., polyethylene terephthalate, PBT, PEEK, PS, and thermosetting polymer materials such as phenolic resins, urea, melamines, epoxy resins, rubber and polyurethanes, in both liquid and solid form, according to the process requirements.

The machine 1 comprises a rotor 2 and a stator 3. The rotor 2 is supported rotatably around an axis of rotation A and is coupled to the stator 3. The rotor 2 comprises a smooth cylindrical (with circular base) outer face 4, i.e. substantially without grooves, notches or recesses.

The stator 3 has a seat 5 for housing the stator 2 defined by a cylindrical inner face 6 (cylinder with circular base).

With reference to FIG. 2, the outer face 4 of the rotor 2 and the inner face 6 of the seat 5 of the stator 3 are concentric and facing and have respective radiuses of curvature such that the play between the rotor 2 and the stator 3 is reduced to a minimum within the tolerances that allow easy rotation of the rotor 2 with respect to the stator 3.

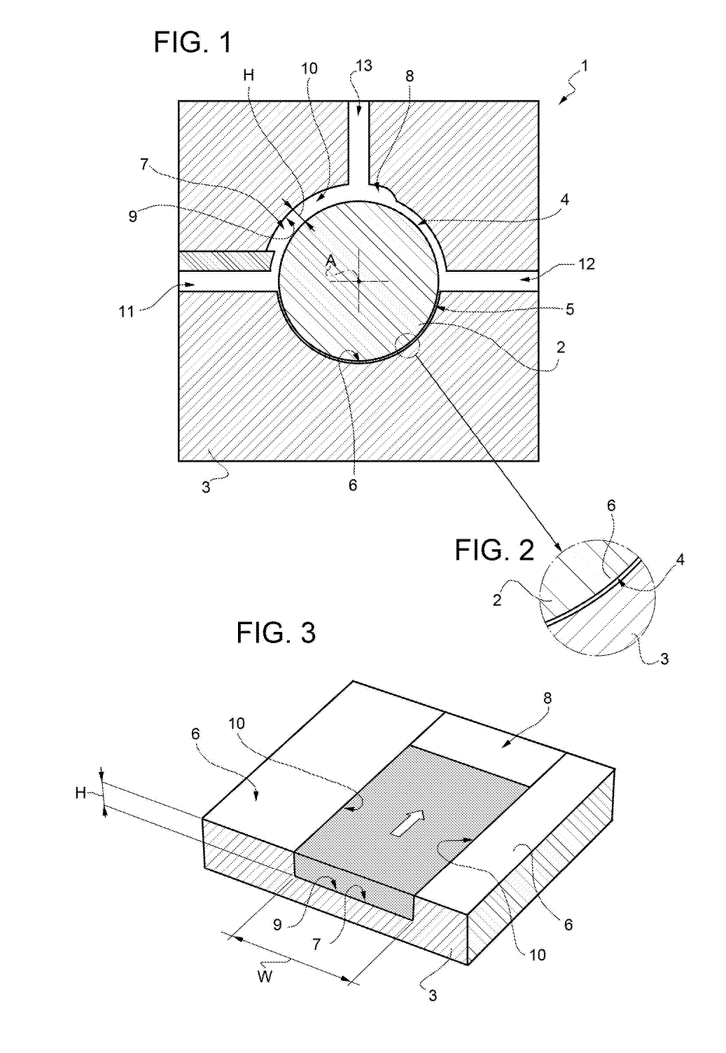

With reference to FIG. 1, in the stator 3 a recess 7 is formed in the seat 5. In particular, the recess 7 extends in a circumferential direction along the face 6 by an angle of less than 360°. In the case illustrated, the recess 7 extends by an angle slightly greater than 180°.

The recess 7 faces the rotor 2 and defines with the rotor 2 a processing channel 8 of the polymer material. The recess 7 has a bottom face 9 and two lateral faces 10, only one of which is illustrated in FIG. 1.

With reference to FIG. 3, the height H of the processing channel 8 is defined by the distance in a radial direction between the outer face 4 of the rotor 2 and the bottom face 9 of the recess 7, while the width W of the processing channel 8 is defined by the distance in an axial direction between the lateral faces 10 of the recess 7. In particular, the lateral faces 10 are parallel to one another and define an annular and not helical processing channel 8.

The height H is as a whole variable, while the width W is maintained normally constant as a consequence of the parallelism of the lateral faces 10.

In the case illustrated in FIG. 1, the height H has a first value constant along a first arc of approximately 10°, increases abruptly to a second value and then increases slightly along an arc of approximately 90°. The height H is then abruptly reduced and again remains constant along the remaining part.

The machine 1 comprises an inlet channel 11 for feeding the polymer materials to the processing channel 8, and an outlet channel 12 for evacuating the polymer materials from the processing channel 8. The processing channel 8 extends between the outlet of the inlet channel 11 and the inlet of the outlet channel 12.

It should be noted that the machine 1, when used for processing liquids, has an inlet channel 11 shaped so as to lower the height of the processing channel 8 in the vicinity of the outlet of the inlet channel 11. Said lowering, as already mentioned, extends by an arc of approximately 10°.

The machine 1 furthermore comprises a feeding channel 13 configured to feed aggregates or agglomerates of elementary solid particles into the processing channel 8 to be infiltrated and dispersed in the polymer material present in the processing channel.

In use, the rotor 2 is rotated clockwise in FIG. 1 so as to feed the polymer material forward along the processing channel 8 between the inlet channel 11 and the outlet channel 12 and at the feed channel 13.

Downstream of the feed channel 13 the reduction in the height H of the processing channel 8 determines a pressure increase in the polymer material and a pumping effect on the polymer material itself, when it is in liquid form. In general, the polymer material can be fed in the solid state and be melted inside the processing channel 8 or can be fed in the pasty liquid state.

FIG. 3 shows the processing channel 8 arranged on rectangular coordinates, with the polymer material entering in granular solid form and being melted to become a liquid after a certain portion in the direction of the arrow. The speed discharged by the rotor 2 onto the solid material in the first portion of the processing channel 8, in the direction of the arrow, and the speed component parallel to the threads imparted to the material in the second portion, in which the material is in the liquid/pasty state, substantially coincide with the speed of the rotor 2, in the vicinity of the rotor surface. The reduction in the height H of the processing channel 8, when used to melt thermoplastic solids, has the purpose of both compensating the space which is reduced due to the apparent density of the solids which is lower than the density of the melted mass and of facilitating infiltration of the newly formed melted material into the interstices between the solid particles so as to increase the interface between the solid material and the material in the liquid/pasty state and, thus, the efficiency of the melting process. It should be remembered that optimal design of the converging channel (both the convergence gradient dh/dL, linear or non-linear) includes the targeted generation of a mixing-dissipation mechanism which occurs when solid particles are completely immersed in a melted matrix. This situation occurs in the machine 1 because the depth H is much smaller than the width W and, therefore, with the same flow section, W is given priority over H in quantity terms. In this situation all or almost all the solid thermoplastic particles are able to receive a considerable quantity of thermal energy, by conduction, from the surrounding melted material. On the other hand, reduction of the height H of the processing channel 8, when used for thermoplastic liquids, has the purpose of discharging elongational stress on the liquids that facilitates dispersion of the liquids and infiltration of the solid agglomerates dispersed in the liquids.

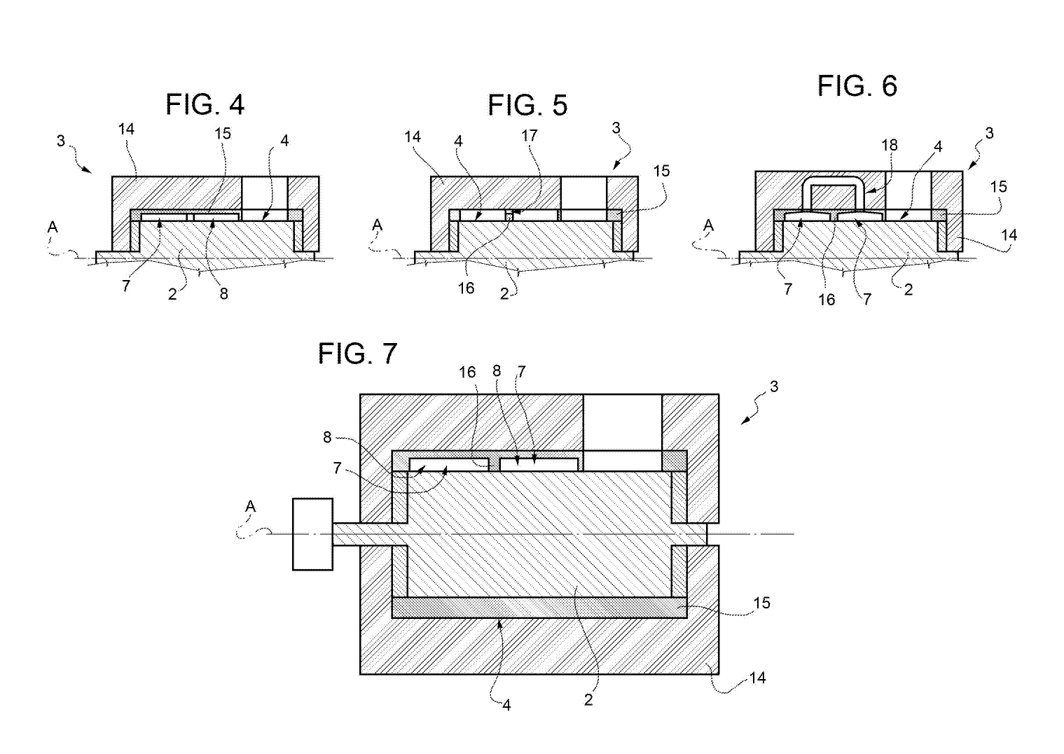

With reference to FIGS. 4 and 7, the stator 3 comprises a body 14 and a tubular element 15, which is arranged around and in sliding contact with the outer face 4 of the rotor 2 and coupled to the body 14. The tubular element 15 has a plurality of parallel recesses 7 each of which defines a respective processing channel 8.

FIG. 5 illustrates a variation according to which two adjacent processing channels 8 are separated by a partition 16 in which an aperture 17 is formed to establish communication between the two adjacent processing channels 8.

FIG. 6 illustrates a further variation according to which the communication between two adjacent processing channels 8 is provided by means of a connection channel 18 which extends through the tubular element 15.

With reference to the embodiments of FIGS. 5 and 6, the adjacent processing channels 8 can have different shapes and be used for different purposes.

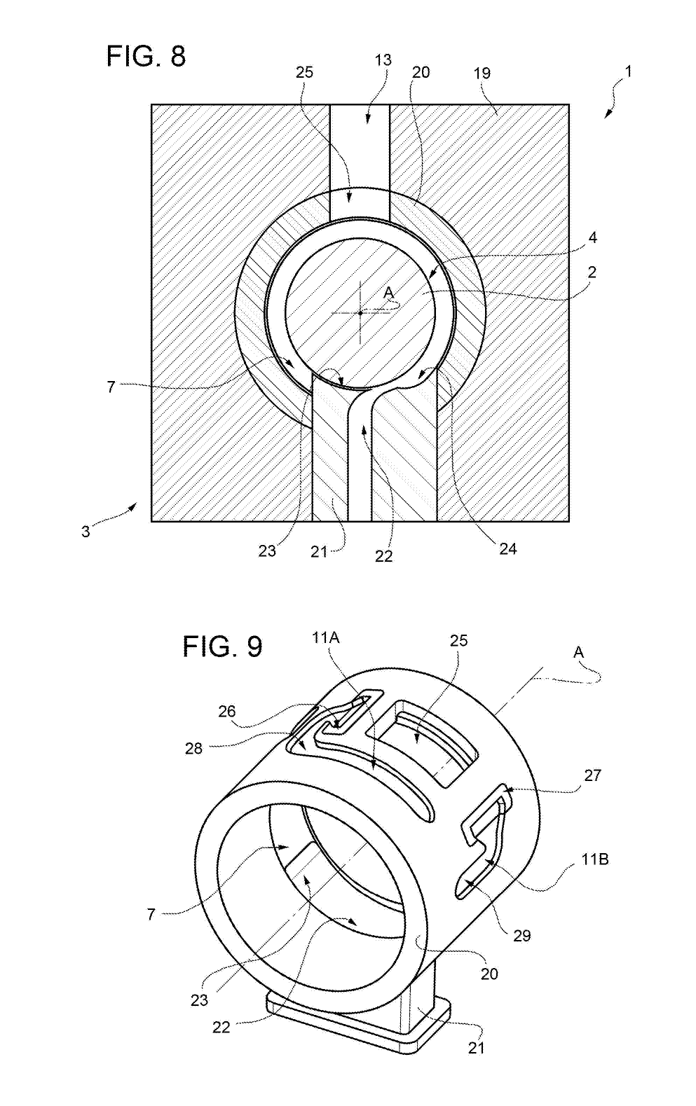

With reference to FIG. 8, the machine 1 for processing polymer materials comprises a stator 3 comprising a body 19 formed of one or more components, a tubular element 20 coupled to the body 19, and an element 21, in which the outlet channel 22 is formed and is coupled to the body 19 and to the tubular element 20. The tubular element 20 is coupled by dynamic seal with the outer face 4 of the rotor 2 and has a recess 7 which defines together with the rotor 2 the processing channel 8. The tubular element 20 is sealingly coupled with the cylindrical face 6 of the stator 3.

The tubular element 20 has an aperture housing the element 21 which is, in part, coupled to the rotor 2 so as to interrupt the processing channel 8 and in apart defines the terminal portion of the processing channel 8. In practice, the element is defined by a parallelepiped, inside which the outlet channel 12 is formed. The element 21 has one end comprising a concave cylindrical face 23 and configured to be slidingly coupled to the face 4 of the rotor 2, and one end comprising a concave face 24 configured to define a terminal portion of the processing channel 8.

With reference to FIG. 9, the tubular element 20 has a further aperture 25 which defines part of the feed channel 13; and two inlet mouths 26 and 27 for feeding the polymer materials to the processing channel 8 and arranged upstream and downstream of the aperture 25 respectively.

The two inlet mouths 26 and 27 communicate with respective inlet channels 11A and 11B which are in part defined by respective recesses 28 and 29 provided along the outer face of the tubular element 20 and in part are defined by inlets provided in the body 30 of the stator 3, not shown for the sake of simplicity.

The configuration described of the inlet mouths 26 and 27 and of the aperture 25 of the feed channel 13 allow a layer of polymer material, a layer of agglomerates of elementary particles and a layer of polymer material to be inserted in sequence in the processing channel 8 so as to define a sandwich which facilitates the phases of infiltration of the agglomerates and dispersion of the particles.

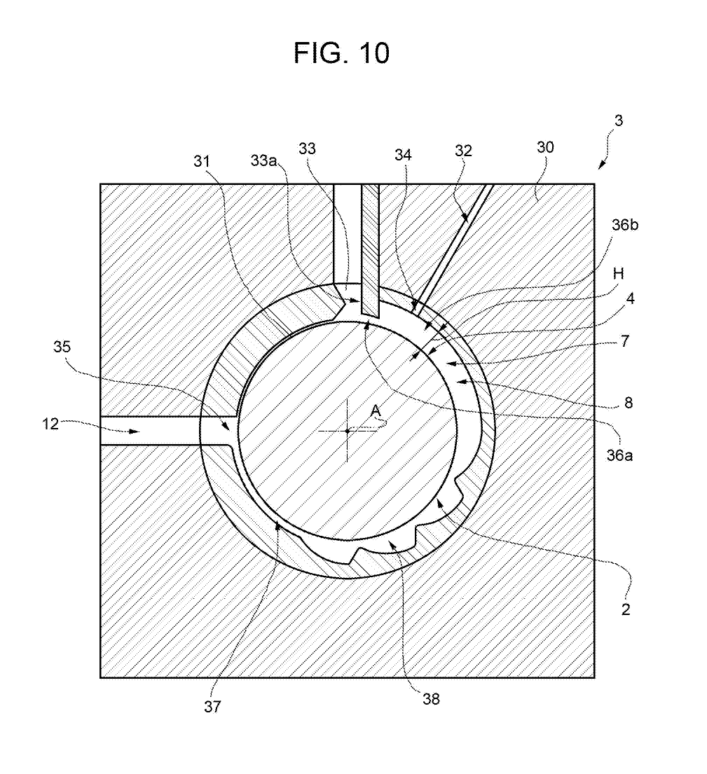

With reference to the variation of FIG. 10, the machine 1 has a stator 3 comprising a body 30, a tubular element 31 and a degassing channel 32. In the case illustrated, the tubular element 31 comprises an inlet mouth 33 for feeding the polymer materials; a thinning area 33a to reduce the thickness of the liquid polymer film at the inlet of the processing channel 8; a degassing aperture 34 defining the inlet part of the degassing channel 32; an outlet mouth 35 defining part of the outlet channel 12.

The tubular element 31 comprises a recess 7, which extends from the inlet mouth 33 to the outlet aperture 35 and defines the processing channel 8.

The recess 7 has a variable height along the circumferential development. In particular, the recess 7 is shaped so that the processing channel 8 comprises, in sequence, a first portion 36a with constant height H to facilitate the formation of a thin film, a second portion with constant height H which extends downstream of the degassing aperture 32, a third portion 37 with constant height and arranged directly upstream of the outlet aperture 35 with pumping functions, and a fourth portion 38 between the second portion 36b and the third portion 37 and defining three converging/diverging sections and a section converging towards the third portion 37.

The inlet mouth 33 has the function of spreading a thin film of polymer material on the outer face 4 of the rotor 2. Said layer of polymer material has a height decidedly lower than the height H of the portion 36b of the processing channel 8, does not dirty the degassing aperture 34 and allows definition along the portion 36b of a degassing chamber, in which the liquid to be degassed and the processing channel 8 at the degassing aperture 34 are completely separate from each other.

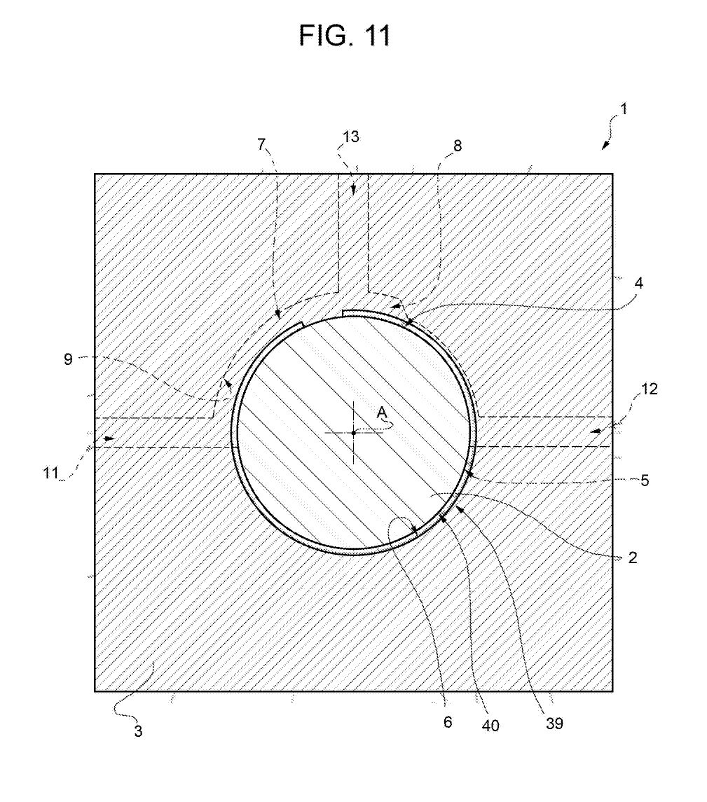

With reference to FIG. 11, the machine 1 comprises a recirculation system 39, which has the purpose of limiting and possibly eliminating the possible leaks of polymer material via the necessary play between the rotor 2 and the stator 3, along the two lateral ends of the processing channel 8. The recirculation system 39 is configured to generate a dragging recirculation flow external to the processing channel 8 which collects polymer material on the opposite sides of the processing channel 8 in high pressure areas of the processing channel 8 and introduces the polymer material into low pressure areas of the processing channel 8.

With reference to FIG. 11, the recirculation channel 40 extends around the axis A along an arc of a circle between an area of high pressure and an area of low pressure of the processing channel 8.

The recirculation channel 40 is substantially parallel to the processing channel 8 from which it receives melt-liquid by lateral transfer and is activated by the rotor 2 which, when in rotation, entrains the above-mentioned melt-liquid, conveying it again into the same processing channel 8 at a point with lower pressure.

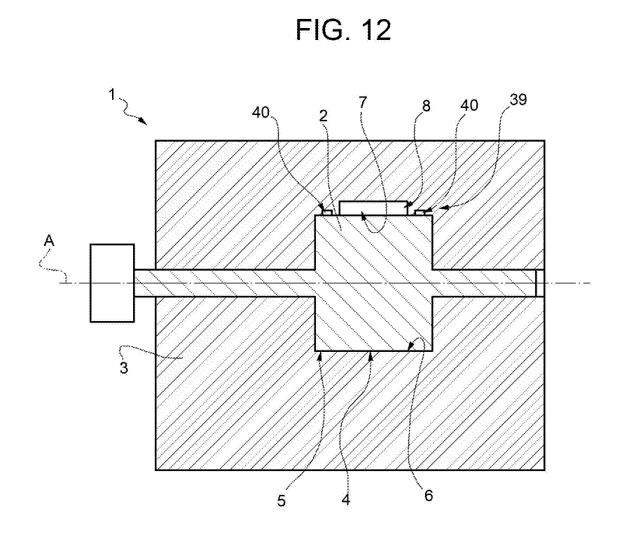

In FIG. 12 the recirculation channels 40 are arranged on opposite sides of the processing channel 8 and are axially spaced with respect to the processing channel 8 in the high pressure areas. In the low pressure area of the processing channel 8, the recirculation channels converge towards the processing channel 8 and flow back into the processing channel 8 itself.

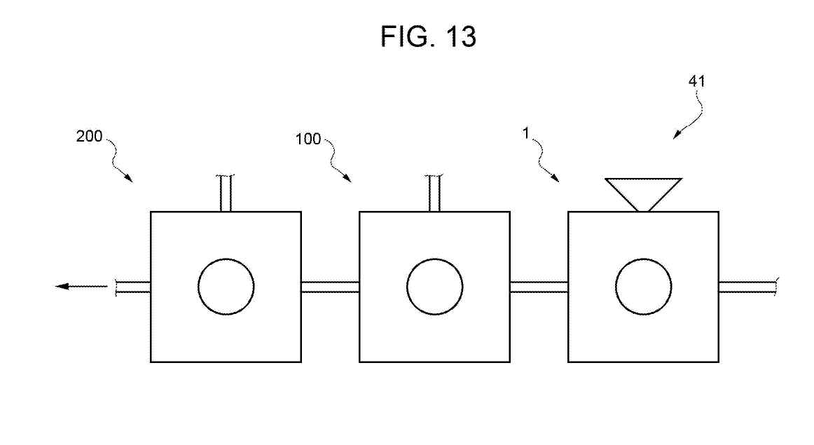

FIG. 13 illustrates a plant for processing polymer material. The plant comprises three machines 1, 100, 200 for processing polymer material connected in series.

For example, the first machine 1 melts the polymer material and pumps it to the second machine 100, which disperses agglomerates of solid particles or liquid particles in the polymer material and pumps it to the third machine 200, in which the degassing of the polymer material takes place.

It is evident that a machine of the type described can be operatively connected upstream and/or downstream of other machines of different type.

Machines of the type described can be advantageously used both for the production of composite granules for use in subsequent injection moulding processes or for producing in line extruded profiles or tubes or sheets loaded with micro or nano loads or reinforced with fibres, such as carbon glass fibres, aramid fibres, natural fibres etc.

The functional connection of a machine of the type described above with conventional screw extruders, injection machines, blow moulding machines, presses for compression moulding etc., both in cascade and in bypass, etc., is of particular practical interest.

Lastly, it is obvious that variations to the embodiments described can be made to the present invention without departing from the protective scope of the attached claims.

1. A machine for processing polymer materials, the machine comprising a rotor rotatable about an axis of rotation; a stator slidingly and sealingly coupled with the rotor; at least one circumferential recess extending along an angle lesser than 360° in the stator and forming with the rotor a processing channel for processing the polymer material; at least one inlet channel for feeding the polymer material to the processing channel; and an outlet channel for evacuating the polymer material from the processing channel.

2. A machine as claimed in claim 1, wherein the recess extends in an annular direction orthogonal to the axis of rotation.

3. A machine as claimed in claim 1, wherein the recess has a constant width measured parallel to the axis of rotation.

4. A machine as claimed in claim 1, wherein the recess has a bottom face arranged at a distance from the rotor so as to determine a variable height of the processing channel.

5. A machine as claimed in claim 4, wherein the processing channel comprises a first portion arranged at the inlet channel having a first constant height; a second portion arranged at the outlet channel having a second constant height and less than the first height of the first portion.

6. A machine as claimed in claim 5, wherein the processing channel comprises a third portion arranged between the first and the second portion and having a third variable height so as to define at least one convergent flow section.

7. A machine as claimed in claim 6, wherein said third portion has a plurality of convergent/divergent flow sections.

8. A machine as claimed in claim 1, wherein the rotor has an outer face cylindrical and substantially smooth.

9. A machine as claimed in claim 1, and comprising a feed channel for supplying to the processing channel agglomerates of elementary particles configured to be infiltrated and dispersed in the polymer matrix.

10. A machine as claimed in claim 9, wherein the inlet channel comprises two inlet mouths arranged in succession along the processing channel respectively upstream and downstream of the feed point of the agglomerates of elementary particles so as to feed the agglomerates between two layers of polymer material.

11. A machine as claimed in claim 1, and comprising a degassing channel configured to eject the gases generated during the processing of the polymer material.

12. A machine as claimed in claim 1, and comprising a recirculation system to collect the polymer material at the liquid/pasty state that escapes from the opposite sides of the processing channel and convey said polymer material to the processing channel.

13. A machine as claimed in claim 12, wherein the recirculation system comprises at least two recirculation channels which extend in the stator on opposite sides of the processing channel and flow into the processing channel in a low pressure zone.

14. A machine as claimed in claim 1, and comprising a plurality of adjacent processing channel formed inside the stator.

15. A machine as claimed in claim 13, in which the adjacent processing channels have different shapes from each other.

16. A machine as claimed in claim 1, wherein the stator comprises a body, and a tubular member arranged around the rotor and in sliding contact with the rotor, and sealingly coupled to the body; the said at least one recess being formed along the inner face of the tubular element.

17. A machine as claimed in claim 16, wherein the tubular element has at least one additional recess formed along the outer face of the tubular element itself and configured to define, in part, the inlet channel.

18. A plant for processing a polymer material, the plant comprising a plurality of machines for processing a polymer material, each as claimed in claim 1, wherein said machines are connected in series together.
